(19) United States
(12) Patent Application Publication
(10) Pub. No.: US 2012/0180448 A1
(43) Pub. Date: Jul. 19, 2012

(54) ROTATING ASSEMBLY FOR GRASS TREATMENT DEVICE

(75) Inventors: TOM SLATER, SHEFFIELD (GB); JOHN COLEMAN, SHEFFIELD (GB); JACK COPELAND, SHEFFIELD (GB)

(73) Assignee: ADVANCED ENGINEERING TECHNIQUES LIMITED, SHEFFIELD (GB)

(21) Appl. No.: 13/007,768

(22) Filed: Jan. 17, 2011

(51) Int. Cl. A01D 43/02; A01D 34/73; A01D 34/00

(52) U.S. Cl. 56/193; 56/229; 56/255

(57) ABSTRACT

A grass treatment device (100) is provided, which comprises a frame (101), at least one roller (104) mounted to the frame and configured to contact a grass surface and a grass treatment tool (105) mounted to the frame substantially adjacent the roller and configured to treat the grass surface. The grass treatment device (100) comprises a rotating assembly (108) mounted substantially adjacent the roller (104) and having a plurality of bristle members (110), and driving means (114) operably connecting the rotating assembly to the roller. The driving means comprises a gear mechanism having a first driving gear (115) attached to an axis of the roller and a first driven gear (116) attached to an axis of the rotating assembly, whereby motion of the roller (104) is translated to the rotating assembly (108).

### FIELD OF THE INVENTION

The present invention relates to a rotating assembly associated with a roller of a grass treatment device. More particularly, the invention relates to a driven rotating assembly for improving operation of the grass treatment device.

### BACKGROUND TO THE INVENTION

Grass treatment apparatuses are used for treating and maintaining grass surfaces such as lawns, playing fields, parks and golf courses. Types of grass treatment tools used in such devices include, but are not limited to mowers, rollers, scarifiers and spikers.

In most cases the grass treatment tool is preceded and followed by an associated roller. Each roller acts to position the grass treatment tool relative to the surface which is being treated, and to flatten it. A combination of front and back rollers places the grass treatment tool in an optimum position.

In the case of a grass treatment device configured to cut, aerate, scarify or mow the grass, a common occurrence on the second roller, which follows the first roller and the cutting blades of the tool, is an accumulation of cut grass fragments and other debris. The accumulation of these cut grass fragments and debris can impede the operation of the grass treatment device, as the second roller is unable to perform its flattening and positioning functions properly.

Mechanisms have been devised previously, which attempt to keep the second roller reasonably free from cut grass fragments and other debris whilst in use. A first known solution involves the suspension of a wire, or a comparable resilient member, in proximity to the surface of the second roller. This wire is spaced a pre-determined distance away from the surface of the second roller, or may even be positioned in contact with this surface. If it is disposed a distance away from the surface, a quantity of material will first accrete onto the surface of the second roller, without touching the wire. The accreted material eventually reaches a sufficient depth relative to the roller surface to come into contact with the wire, which removes it at that time. Another known solution involves a fixed brush, comprising a number of bristle members, again either spaced a pre-determined distance away from the surface of the second roller, or positioned in contact with this surface. These known solutions exhibit several disadvantages, however.

For wires not in contact with the second roller surface, a significant amount of debris can accrue upon the surface of the second roller before it is dispersed and, for fixed brushes, a significant amount of debris can accrue at or within the bristle members before it is dispersed. This is a problem because, on highly manicured grass surfaces, for instance golf courses, fairways and in particular greens, the debris from the cutting process should, inasmuch as possible, be distributed evenly across the complete surface of the area being treated. This cannot be achieved with the wire or the fixed brush, which are too imprecise, because they do not impart any direction or momentum to the particles of material removed from the second roller surface. Moreover, although the surface of the second roller is kept relatively clean of debris and other materials, the removed material is deposited at, or very close to, the position of the device as the cleaning operation occurs, rather than being distributed evenly across the treated surface.

Known rotating brush assemblies, again located in proximity to the second roller, address some of the problems associated with the above known solutions. When the grass treatment device uses a powered tool, for instance a grass mower, the blades which perform the mowing operation are driven by a motor associated with the grass treatment device. It is known to drive a rotating brush assembly with the same motor and this arrangement rotates the brush cylinder at a relatively high RPM, the brush cylinder being configured such that the bristle members protruding from the brush cylinder contact the surface of the second roller. When a bristle member contacts any debris on the roller surface, the debris is ejected from the surface of the second roller in a highly-kinetic manner, due to the momentum and direction imparted upon this debris by the rotating bristle member.

A number of disadvantages are still associated with this solution to the problem of maintaining and cleaning roller surfaces. In particular, as the brush cylinder is driven by the motor which also drives the grass treatment tool of the grass treatment device, specific gearing arrangements are necessary between the motor and the brush cylinder, in order to ensure smooth operation of the brush cylinders. In particular, a high gear ratio is necessary between the motor and brush cylinder in order to ensure a sufficient RPM of the cylinder for making it suitable for the purpose. U.S. Pat. No. 6,029,433 and U.S. Pat. No. 5,682,735 respectively disclose examples of such specific gearing arrangements.

Moreover, it is also necessary to provide a clutch mechanism between the engine of the grass treatment device and the brush cylinder since, when the grass treatment device is stationary but the engine is in operation, it would be unproductive to allow the brush cylinder to continue to revolve and impact a small constant portion of the surface of the second roller, as this would wear the bristle members unnecessarily.

Grass treatment devices also exist, which are not driven by a motor. An example is a sarel roller, having an number of spikes protruding from the surface of a roller. The spikes are configured to pierce a grass surface when the device is in use, and the interaction of the spikes with the surface causes the roller to rotate. Since the motor does not provide any power to the sarel roller, a specific driving means would be required for connecting the motor and the rotating brush, in order to activate the brush.

The inventors, seeing the need to ensure one or both rollers remain free of debris but also appreciating the disadvantages of the current solutions, have arrived at their invention.

In particular, the inventors have provided a simplified means of ensuring the surface of either roller remains free of debris, which imparts sufficient momentum and direction to any debris for ensuring as even a distribution of ejected debris over the grass surface being treated as possible.

### SUMMARY OF THE INVENTION

According to a first aspect, there is provided a grass treatment device comprising a frame, at least one roller mounted to the frame and configured to contact a grass surface and a grass treatment tool mounted to the frame substantially adjacent the roller and configured to treat the grass surface. The grass treatment device is characterised by further comprising a rotating assembly mounted substantially adjacent the roller and having a plurality of bristle members, and driving means operably connecting the rotating assembly to the roller, comprising a gear mechanism having a first driving gear attached to an axis of the roller and a first driven gear attached to an axis of the rotating assembly.

The inventors provide a cleaning assembly in the form of a rotating assembly with bristle members, which is driven by the roller of a grass treatment device and imparts momentum and direction to any debris removed from the surface of the roller, and does not require a distinct power source.

Furthermore, the rotating assembly is driven by a driving means which connects the cleaning mechanism and the roller. In this way therefore, the rotating assembly does not need an associated clutch or gearing system as it is not operably connected to the motor which is configured to drive one or more components of the grass treatment device, such as the grass treatment tool. The driving means comprises a gear mechanism, as the inventors have realised the use of a geared mechanism for operably driving the rotating assembly via movement of the roller is preferable to the use of a belt, which tends to become clogged with cuttings and debris over time, when in use.

According to a second aspect, there is provided a kit of parts for a grass treatment device comprising at least one roller configured to contact a grass surface and a grass treatment tool substantially adjacent the roller and configured to treat a grass surface, the kit of parts comprising a rotating assembly apt to be mounted substantially adjacent the roller, comprising a plurality of bristle members; and driving means operably connecting the rotating assembly to the roller, wherein the driving means comprises a gear mechanism having a first driving gear attached to an axis of the roller and a first driven gear attached to an axis of the rotating assembly.

Preferably, the first driving gear and the first driven gear are selected from the group comprising toothed gears, smooth gears and worm gears.

Preferably, the gear mechanism further comprises an idler gear located between the driving gear and the driven gear, so that the rotating assembly and its bristle members may rotate in the same direction as the roller.

Embodiments may therefore include either a toothed idler gear, which is positioned between a toothed driving gear attached to the roller axis and a toothed driven gear attached to the rotating assembly axis, or a smooth idler gear, which is positioned between a smooth driving gear attached to the roller axis and a smooth driven gear attached to the rotating assembly axis.

The first driving gear, the first driven gear and the optional idler gear may be substantially circular, and may further made from a substantially resilient material, for instance neoprene.

The grass treatment device preferably further comprises adjusting means apt to adjust a distance between the rotating assembly and the roller. The adjusting means is preferably an eccentric mount operable to adjust a distance between the driving gear and the driven gear, so that a distance between the rotating assembly and the roller may be correspondingly adjusted.

The eccentric mount accommodates the axis of the rotating assembly and offsets the first driven gear relative to the first driving gear or to an optional idler gear, so that a user may define a permanent distance between the respective teeth of the gears.

By providing means to adjust the distance between the rotating assembly and the surface of the roller, the user of the grass treatment device may adjust the interaction of the cleaning mechanism with the surface of the roller. If appropriate, the bristle members of the rotating assembly may not be in contact with the surface of the roller, allowing the roller to accrue a certain amount of debris and cuttings before this material is dispersed by the rotating assembly away from the surface of the roller.

Alternatively the rotating assembly may be brought into greater proximity with the roller. In this instance the bristle members would be in contact with the surface of the roller, such that no material would be allowed to accrue upon the surface of the roller, since all such material would be immediately removed by the cleaning mechanism following its interaction with the roller surface.

Preferably, the driving means is sealed in a housing, for preventing ingress of cuttings and debris within the gear mechanism over time. The housing is preferably made of a durable material, selected from the group comprising steel alloys, elastomer compounds and polymer compounds. The housing preferably comprises respective apertures for accommodating the respective axes of the roller and the rotating assembly, the apertures being sealable by a seal or gasket.

The rotating assembly preferably comprises an elongate body apt to rotate about its longitudinal axis. By providing the cleaning mechanism in the form of a body which is configured to rotate about its longitudinal axis, the cleaning mechanism can be made to mimic the motion of the roller of the grass treatment device. In this way multiple portions of the cleaning mechanism can be brought into contact with multiple portions of the surface of the roller in a time-dependent fashion, depending upon the relative rates of rotation of the second roller and the cleaning mechanism.

By imparting a rotating motion to the cleaning mechanism, this also ensures that the required momentum and direction is imparted to the debris contacted by the cleaning mechanism upon the surface of the roller and that this debris is discharged in a suitable manner, away from the grass treatment device and evenly distributed upon the surface of the area being treated.

The bristle members are preferably disposed about the rotating assembly either randomly or according to a pattern, and extend at an angle relative to the surface or longitudinal axis of the body.

By providing a cleaning mechanism comprising bristle members which constitute at least one brush portion, the interaction of the bush portion or portions with debris and other material accrued upon the surface of the roller imparts the requisite momentum and direction to this debris for projecting it material away from the surface of the roller.

An important consideration to the cleaning mechanism is that, if it comprises brush portions or other components configured to contact the surface of the cylinder along a substantial portion of surface, this may cause both the cylinder and the cleaning mechanism to slow down due to the frictional braking action of the cleaning mechanism upon the surface of the roller. To prevent this, the brush portions of the cleaning mechanism may be disposed in a substantially helical arrangement upon the surface of the body. The brush portions may optionally or alternatively comprise an interval arrangement of brush strips.

In extreme circumstances, the driving means connecting the roller and the rotating assembly may be damaged by the mechanical stress from the braking action of the brush portions upon the roller. The helical arrangement of the brush portion means that only a portion of all the bristle members of the cleaning mechanism are in contact with the roller at any given time, whereby the amount of frictional contact between the roller and the cleaning mechanism is limited, meaning that the rotation of the roller and cleaning mechanism is not substantially impeded by this contact between the two structures.

The bristle members preferably constitute at least one brush portion disposed in a substantially helical arrangement. Alternatively, the bristle members constitute a plurality of discrete brush portions spaced from one another at intervals.

The grass treatment device preferably further comprises fastening means for releasably fastening the rotating assembly to the frame opposite the driving means. The fastening means may advantageously comprise a fastener member engaging the cleaning mechanism axis. Preferably, an outer surface of the fastener member includes at least one depression for engaging at least one complementary projection on an inner surface of the cleaning mechanism axis. Alternatively, an outer surface of the fastener member includes at least one projection for engaging at least one complementary depression on an inner surface of the cleaning mechanism axis. The at least one projection may be a biased ball and the at least one depression may be a socket.

For optimal removal of debris and cuttings from the roller and their subsequent dispersion, a ratio of rotation between the roller and the rotating assembly is preferably selected from the group comprising a non-integer ratio and a ratio greater than 1:1 and less than 1:6. The rotating assembly is preferably configured to rotate between 750 to 2500 rpm during use.

Providing a non-integer relationship being the driving portion of the roller and the driven portion of the rotating assembly ensures that the cleaning mechanism rotates relative to the roller in a non identical manner, whereby different portions of the roller are contacted by different portions of the cleaning mechanism over a given unit of operational time.

The preferred range of gear ratio between the driving portion of the roller and the driven portion of the rotating assembly is believed to be optimal for achieving a rotational speed of the cleaning mechanism sufficient to clean the surface of the roller, whilst preventing premature wear of the assembly and/or the roller.

The grass treatment tool preferably comprises a removable grass treatment cassette, selected from the group comprising a spiker, a scarifer, a rotary brush, a roller, a vibrating roller and a cutter.

The grass treatment device preferably comprises comprising a positioning means configured to contact a grass surface when in use and positioned substantially in front of said grass treatment tool. The positioning means may advantageously be selected from the group comprising skids, a roller and wheels.

According to a further aspect, there is provided a method of cleaning a roller of a grass treatment device comprising the roller, a grass treatment tool configured to treat a grass surface, a rotating assembly mounted substantially adjacent the roller and having a plurality of bristle members, and driving means comprising a gear mechanism having a first driving gear and a first driven gear, the method comprising the steps of operably connecting the first driving gear to an axis of the roller; operably connecting the first driven gear to an axis of the rotating assembly; and bringing the plurality of bristle members into contact with the roller in use.

According to another aspect, there is provided a method of grooming a grass surface before treatment by a grass treatment device comprising a roller, a grass treatment tool configured to treat the grass surface, a rotating assembly mounted substantially adjacent the roller and having a plurality of bristle members, and driving means comprising a gear mechanism having a first driving gear and a first driven gear, the method comprising the steps of operably connecting the first driving gear to an axis of the roller; operably connecting the first driven gear to an axis of the rotating assembly; and bringing the plurality of bristle members into contact with the grass surface in use.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a schematic representation of a grass treatment device according to a first embodiment of the present invention, including a cleaning mechanism.

FIG. 2A is a side view of the driving means of the grass treatment device shown in FIG. 1.

FIG. 2B is a side view of the driving means of a grass treatment device according to a further embodiment of the present invention, showing the driving means in a first position.

FIG. 2C shows the driving means of FIG. 2B in a second position.

FIG. 3A is a schematic representation of a grass treatment device according to a further embodiment of the present invention, having sealed driving means.

FIG. 3B is a schematic representation, as a cut away view, of the driving means of the grass treatment device shown in FIG. 3A.

FIG. 4 is a schematic representation of an embodiment of a coupling means between the driving means and an elongate body of the rotating assembly.

FIG. 5A is a schematic representation of a grass treatment device according to a further embodiment of the present invention, in which the cleaning mechanism is dismantled.

FIG. 5B shows the cleaning mechanism of the grass treatment device of FIG. 5A in isolation of the grass treatment device.

FIG. 5C shows the cleaning mechanism of FIGS. 5A and 5B as an exploded view.

FIG. 6A is a schematic representation of a grass treatment device according to a further embodiment of the present invention, including a grooming mechanism.

FIGS. 6B and 6C illustrate respective steps of the substitution of a cleaning mechanism for a grooming mechanism.

### BEST MODE FOR CARRYING OUT THE INVENTION

There will now be described, by way of example, a best mode and several alternative embodiments contemplated by the inventors. In the following description, numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

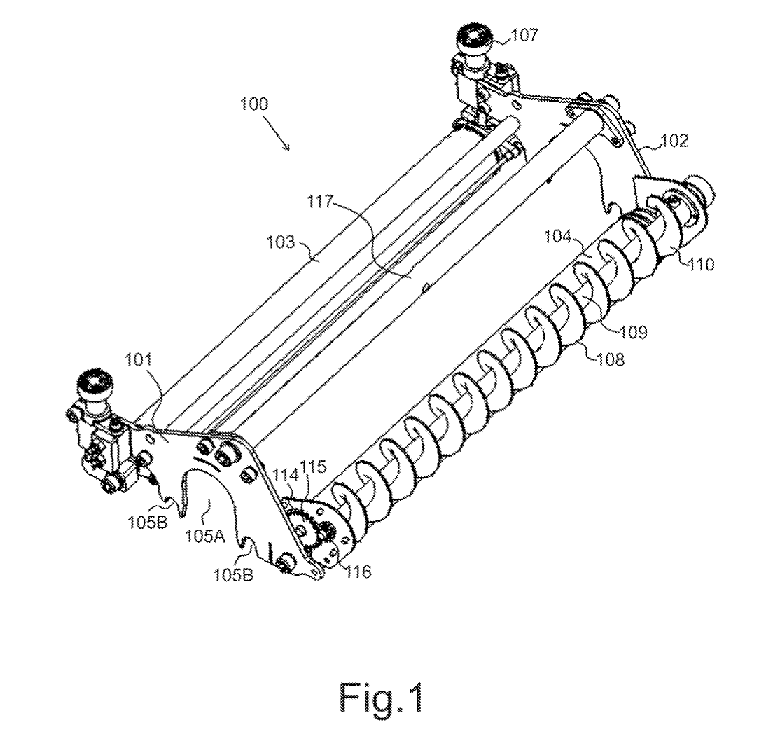

A best mode for carrying out the present invention is shown in FIG. 1, which is a schematic representation of a grass treatment device 100 according to a first embodiment of the present invention, including a cleaning mechanism. The grass treatment device 100 is in the form of a chassis shown in a rear isometric view. The grass treatment device comprises a frame having two end panels 101, 102.

A crossbar piece 117 connects the first and second frame members 101, 102. The crossbar piece 117 increases the structural rigidity and strength of the grass treatment device 100 and, further, acts as a point of contact between a suitably configured towing device or vehicle which, in use, draws the grass treatment device 100 across a grass surface for performing the treatment regime. The grass treatment device 100 therefore further comprises means to attach the grass treatment device 100 to the towing vehicle, such as a tractor or other suitable vehicle. The means of attaching the grass treatment device to the towing vehicle differs between vehicle manufacturers, and the inventors consider the present disclosure to extend to any attachment means or configuration suitable for attaching a grass treatment device 100 according to the invention to a vehicle.

Reference is made hereafter to two rollers 103, 104, since this corresponds to a more conventional configuration in the field of specialist surface grass treatment, however the present invention is equally capable of implementation on a grass treatment device equipped or configured for use with a single roller 104.

In this embodiment, a first roller 103 and a second roller 104 are respectively disposed either side of the end panels 101, 102 and provided to contact the grass surface. The first roller 103 is disposed towards the front end of the device 100 relative to the direction of travel of the grass treatment device 100 when in use. The second roller 104 is disposed towards the rear of the grass treatment device 100, again relative to the direction of travel of the grass treatment device 100 when in use. The rollers 103, 104 are provided to assist in the smooth movement of the grass treatment device 100 over the grass surface, and to maintain a constant height of a grass treatment tool (not shown) relative to the grass surface.

The height of the grass treatment tool 100 may be adjusted relative to the grass surface via an adjustment mechanism 107. The adjustment mechanism 107 comprises a quantified raising and lowering means, which allows the first and second frame members 101, 102 to be raised relative to the roller 103. The first roller 103 is configured to be in contact with the grass surface whilst the device is in use and, by raising and lowering the first and second frame members 101, 102 relative to this first roller 103, the adjustment of any associated grass tool relative to the same grass surface is permitted.

Accordingly the first roller 103 is positioned substantially in front of the grass treatment tool. The grass treatment tool is mounted to the frame substantially adjacent each roller 103, 104 and configured to treat the grass surface. The grass treatment tool is preferably a removable grass treatment cassette respectively carrying out the function of a spiker, a scarifer, a rotary brush, a roller, a vibrating roller or a cutter. A niche 105 is therefore formed into the first and second frame members 101, 102, which is configured to accommodate a mounting portion of the grass treatment tool and therefore comprises a large hemispherical cut out portion 105A, flanked on either side by two smaller hemispherical cut out portions 1058.

The grass treatment device 100 is characterised by further comprising a rotating assembly 108, operably connected to the roller 104. The rotating assembly 108 comprises an elongate body 109 apt to rotate about its longitudinal axis which, in this embodiment, is a cylindrical main body 109. The rotating assembly 108 is mounted substantially adjacent the roller 104, such that the respective longitudinal axes of the roller 104 and the cylindrical main body 109 are substantially parallel to one another.

The rotating assembly 108 comprises a plurality of bristle members 110 disposed on the cylindrical main body 109 in a substantially helical arrangement. The brush is formed in a helical arrangement whereby, when the roller 104 and cleaning mechanism 108 are in motion, only a portion of the helical brush 110 is contact with the surface of the roller 104. This mitigates any braking of the roller 104 through excessive friction with the bristle portions 110.

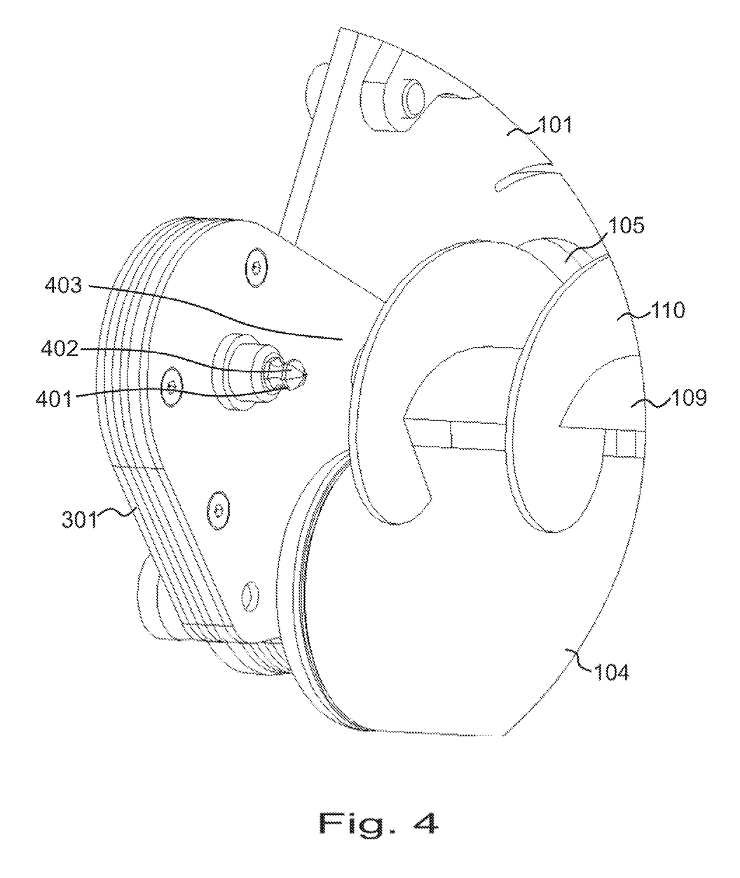

The grass treatment device 100 comprises a driving means 114 for connecting the roller 104 to the shaft or axis of the cleaning mechanism 108. The drive means 114 is configured to translate rotation of the roller 104 into rotation of the cylindrical shaft 109, thereby causing the rotation of its associated helical brush portion 110, which effects cleaning of the surface of the roller 104. The driving means 114 comprises a gear mechanism 114 having a first driving gear 115 attached to an axis of the roller 104 and a first driven gear 116, which is positioned upon an end of the cylindrical shaft 109 of the rotating assembly 108 and connected thereto by means of a coupling means, an embodiment of which is shown in FIG. 4 and further described hereafter.

The first driving gear 115 and the first driven gear 116 are toothed gears, however the present invention is equally capable of implementation with smooth gears and worm gears. An example of a non-toothed gear mechanism would be a driving and driven circular gear operably connected to each other, and covered in a resilient material at least in the region where they contact each other to ensure a smooth but continuous operation. Neoprene is considered particularly suitable as a resilient material.

In use, whenever the grass treatment device 100 is pulled or otherwise driven across a grass surface, the roller 104 in contact with the treated grass surface rotates at all times. This rotation of the roller 104 is translated, via the action of the driving gear 115 unto the driven gear 116, into rotation of the rotating assembly 108 and, specifically, the cylindrical shaft 109 attached to the driven gear 116 and its associated helical brush 110. As the rotating brush portions 110 contact the surface of the roller 104, they likewise contact and remove any debris thereon, imparting momentum and direction at the time of removal.

Multiple bristle portions of the cleaning mechanism 108 are brought into contact with multiple portions of the surface of the roller 104 in a time-dependent fashion, depending upon the relative rates of rotation of the roller and the cleaning mechanism. In the example, the diameter of the driving gear 115 is greater than that of the driven gear 116, translating one revolution of the driving gear 115 into more than one revolution of the driven gear 116. For optimal removal of debris and cuttings from the roller and their subsequent dispersion, a ratio of rotation between the roller 104 and the rotating assembly 108 is preferably greater than 1:1 and less than 1:6, and the rotating assembly 108 is preferably adapted to rotate between 750 rpm to 2500 rpm. The inventors also consider a non-integer ratio to be preferable, as this allows the rotating assembly 108 to rotate asynchronously relative to the roller 104, whereby different portions of the roller 104 are contacted by different portions of the rotating assembly 108 over a given unit of operational time.

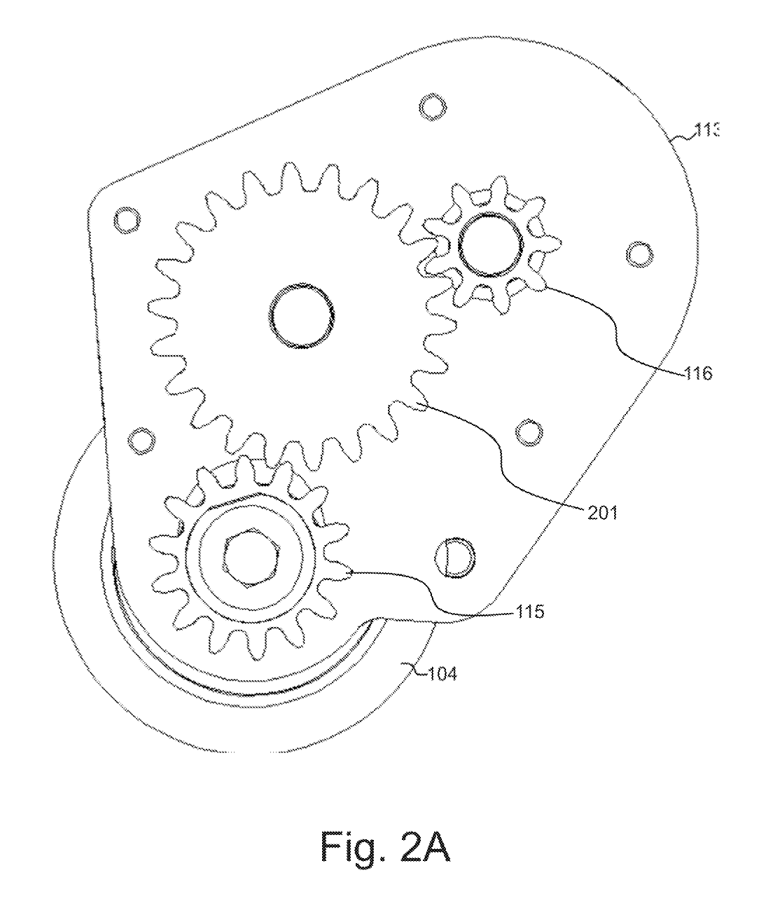

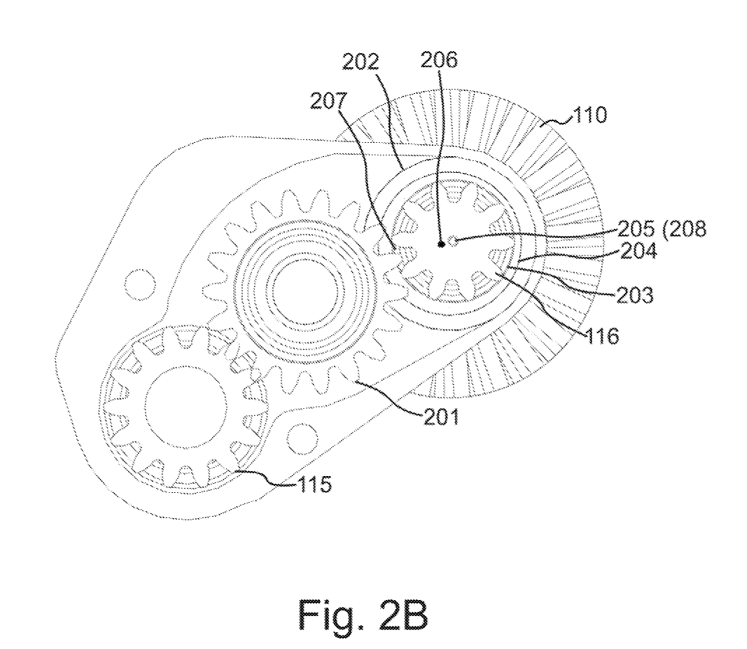

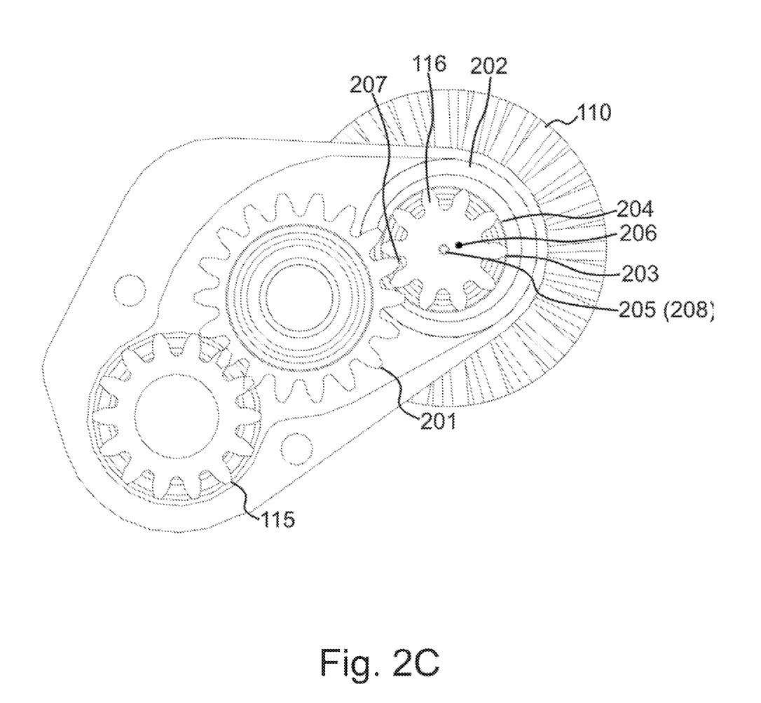

With reference to FIG. 2A herein, there is shown an enlarged view of an alternative embodiment of the drive means 114.

An end or axis of the roller 104 is coupled to the driving gear 115 and, operably connected to this driving gear is an idler gear 201, which is positioned between the driving gear 115 and the driven gear 116. The driven gear 116 is connected to an end or axis of the cylindrical shaft 109, onto the surface of which the helical brush 110 is located, the helical brush being configured to interact with the surface of the roller 104.

The idle gear is positioned between the driving and driven gears so as to ensure rotation of the cylindrical shaft 109 and its associate helical brush portion 110 in the same direction as that of the roller 104.

The engagement of gears 115, 116 and 201 causes any rotation of the roller 104 to be translated into movement of the cylindrical shaft 109 and its associated helical brush 110, wherein movement of the cylindrical shaft 109 is a rotation in the same direction as the rotation of the roller 104.

The brush 110 is designed to clean the surface of the roller 104, however the brush 104 has a tendency to wear over time as it comes into contact with debris cleared from the roller. An alternative embodiment of the invention, shown in FIGS. 2B and 2C, allows a user to adjust a distance between the brush and the roller for compensating the brush wearing

FIGS. 2B and 2C show an enlarged view of another alternative embodiment of the drive means 114, which includes both an idler gear 201 as shown in FIG. 2A and adjusting means 202 apt to adjust a distance between the rotating assembly 108 and the roller 104. The idler gear 201 is considered optional.

The adjusting means 202 is an eccentric mount, or eccentric adjuster, which is operable to adjust a distance between the driving gear 115 and optional idler gear 201, and the driven gear 116, so that a distance between the rotating assembly 108 and the roller 104 is correspondingly adjusted.

The eccentric mount 202 comprises two substantially annular members, an inner annular member 203 and an outer annular member 204, wherein the outer annular member 204 has a diameter apt to accommodate the inner annular member 203. The annular members have respective parallel longitudinal axes 205, 206 which are transversally offset relative to one another by a distance 207.

The eccentric adjuster 202 is therefore a substantially cylindrical component, wherein the driven gear 116 is mounted with its rotational axis radially offset from the rotational axis 206 of the eccentric adjuster 202. The eccentric adjuster 202 is mounted in a driving means 114 which also contains driving and idler gears 115, 201. The respective rotational axes of the driving gear, idler gear and of the eccentric adjuster are in fixed positions, and the rotational axis of the driven gear is in an adjustable position.

The eccentric mount is configured to allow adjustment by rotating the inner annular member 203 within the outer annular member 204 about the longitudinal axis 206 of the outer annular member 204, then releasably securing or fastening the inner annular member 203 in position within the outer annular member 204.

Accordingly, any adjustment of the inner annular member 203 within the outer annular member 204 follows a circular path corresponding to the diameter 207 of a circle concentric with the centre 206 of the outer annular member 204. Rotation of the inner annular member 203 therefore offsets the first driven gear 116 relative to both the idler gear 201 and the first driving gear 115, by a varying distance which depends upon the position of the longitudinal axis 205 of the inner annular member 203 relative to the longitudinal axis 206 of the outer annular member 204, after adjustment and securing or fastening of the inner annular member 203.

The eccentric mount 202, particularly the inner annular member 203, is operably connected both to the driven gear 116 and to the axis 208 of the rotating assembly 108, whereby its longitudinal axis 205 is co-axial with the axis 208 of the rotating assembly 108. Therefore, any adjustment of the distance between the first driven gear 116 and the idler gear 201 is translated into a corresponding adjustment of the distance between the axis 208 of the rotating assembly 108 relative to both the idler gear 201 and the first driving gear 115.

As the first driving gear 115 is co is co-axial with the longitudinal axis of the roller 104, the adjustment of the distance between the axis 208 of the rotating assembly 108 relative to the first driving gear 115 is likewise translated into a corresponding adjustment of the distance between the axis 208 of the rotating assembly 108 and the parallel axis of the roller 104.

A user can therefore define a permanent distance between the respective teeth of the gears and adjust the interaction of the cleaning mechanism 108 with the surface of the roller 104.

The adjustment may be such that bristle members 110 of the rotating assembly 108 are not be in contact at all with the surface of the roller 104. This configuration allows the roller surface to accrue a certain amount of debris and cuttings before this material is dispersed away from the surface of the roller by the rotating assembly.

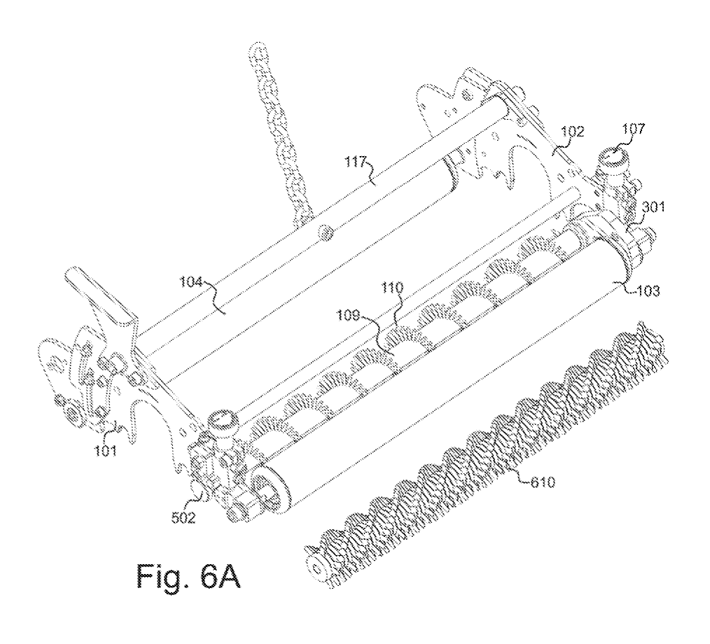

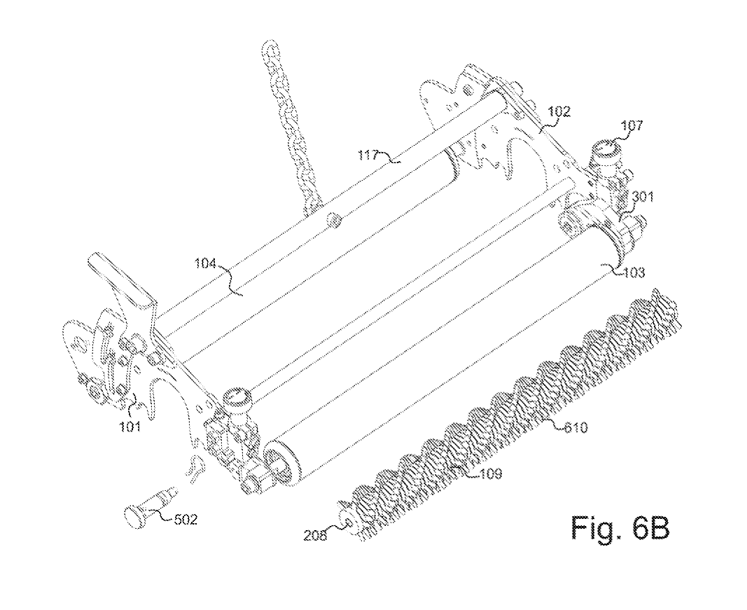

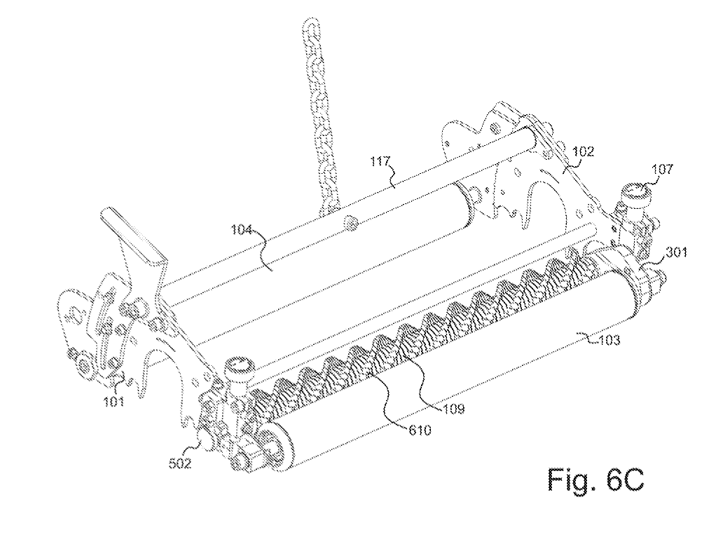

Moreover, it is intended that the eccentric adjuster 202 allows complete disengagement of the idler gear 201 and driven gear 116, so that drive to the rotating assembly 108 may be completely disengaged. For instance, with reference to FIGS. 6A to 6C hereafter, the treatment tool may not generate debris and cuttings, which are therefore unlikely to accrue on the roller surface, whereby interaction between the rotating assembly 108 and the roller 104 may not be desired, and this disengaged configuration prevents unnecessary wear of the rotating assembly and/or the driving means.

Alternatively, the adjustment may be such that the rotating assembly 108 is brought into greater proximity with the roller 104. In this instance the bristle members 110 would be in contact with the surface of the roller, such that no material would be allowed to accrue upon the surface of the roller, since all such material would be immediately removed by the cleaning mechanism following its interaction with the roller surface.

As the treatment tool performs its function on the grass surface, the surface of the roller 104 is kept clean of cuttings and debris, however these may nevertheless eventually ingress and foul the driving means 114 over time. In particular, the inventors have realised that the fouling of driving mechanisms during use, by grass cuttings and debris arising from the operation of the grass treatment tool, particularly of the cutter type, is a frequent problem with belt-driven axles and/or cylinders, and still a potential a problem with any mechanism having moving parts exposed to the elements, such as the driving means 114 of the present invention.

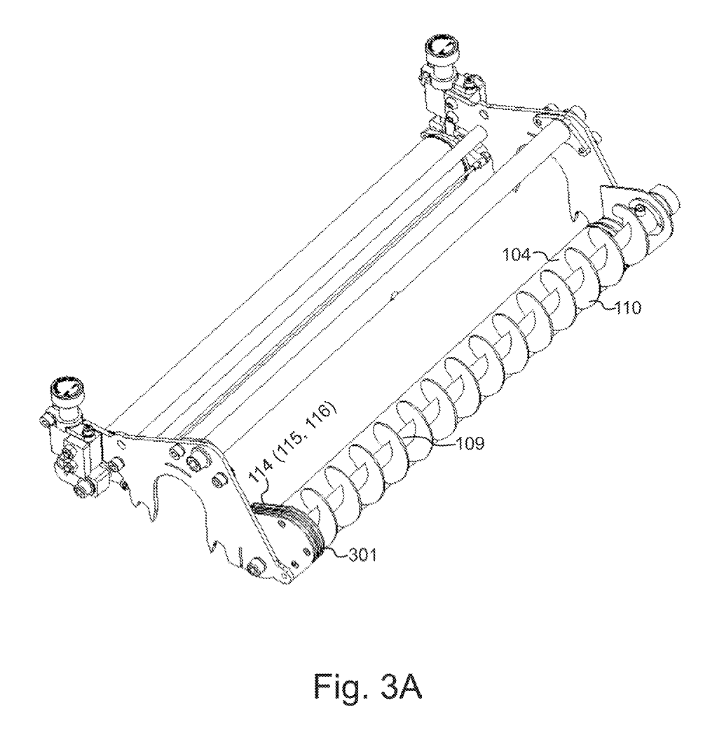

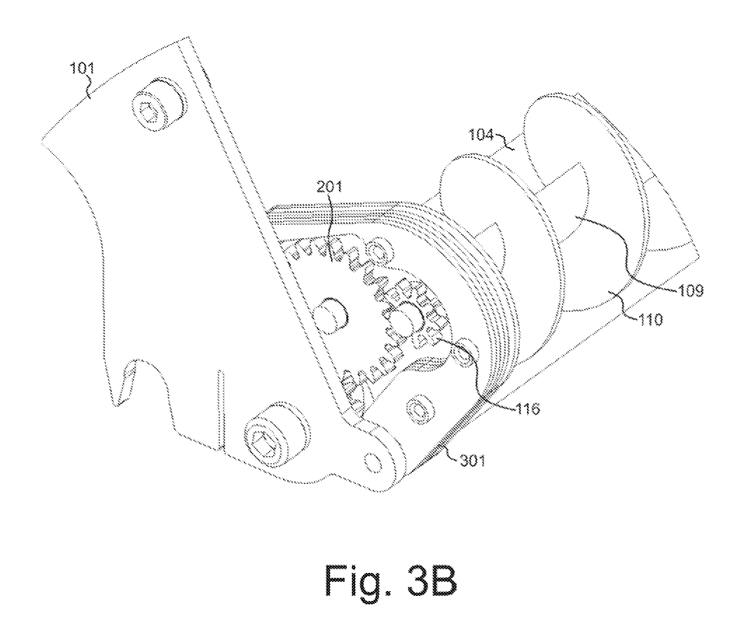

With reference to FIGS. 3A and 3B herein, there is shown a schematic representation of a grass treatment device according to a further embodiment of the present invention, having sealed driving means 114. This embodiment has the additional advantage of reducing the maintenance interval for the drive mechanism. The housing 301 may advantageously comprise a plurality of apertures for accommodating the respective axes of the roller 104 and the rotating assembly 108, the apertures being sealable by a seal or a gasket. The housing is preferably made of a durable material, for instance a steel alloy, an elastomer compound or a polymer compound.

The inventors have also realised that, due to the wearable nature of the brush portions 110, relatively frequent changing of the brush 110 and shaft 109 may be required, particularly where the grass treatment device is in extensive or industrial use.

FIG. 4 is a schematic representation of an embodiment of a quick-release coupling means between the driving means 114 and the rotating assembly 108.

The coupling means comprises a rotating push-fit pin 401, operably connected to the driven gear 116. The pin 401 comprises a plurality of surfaces 402, which are apt to translate the force imparted to the pin by driven gear 116 onto complementary surfaces of a complementary socket 403 (obscured by the perspective in FIG. 4). The complementary socket 403 is disposed substantially at the longitudinal axis of the cylinder 109 and centred relative thereto. In use, the pin surfaces 402 mate with the complementary surfaces of the socket 403, whereby the driving force of driven 116 is translated to the shaft 109, which rotates as a result.

The grass treatment device preferably further comprises fastening means for releasably fastening the rotating assembly to the frame opposite the driving means. The fastening means may advantageously comprise a fastener member engaging the cleaning mechanism axis. Preferably, an outer surface of the fastener member includes at least one depression for engaging at least one complementary projection on an inner surface of the cleaning mechanism axis. Alternatively, an outer surface of the fastener member includes at least one projection for engaging at least one complementary depression on an inner surface of the cleaning mechanism axis. The at least one projection is a biased ball and the at least one depression is a socket.

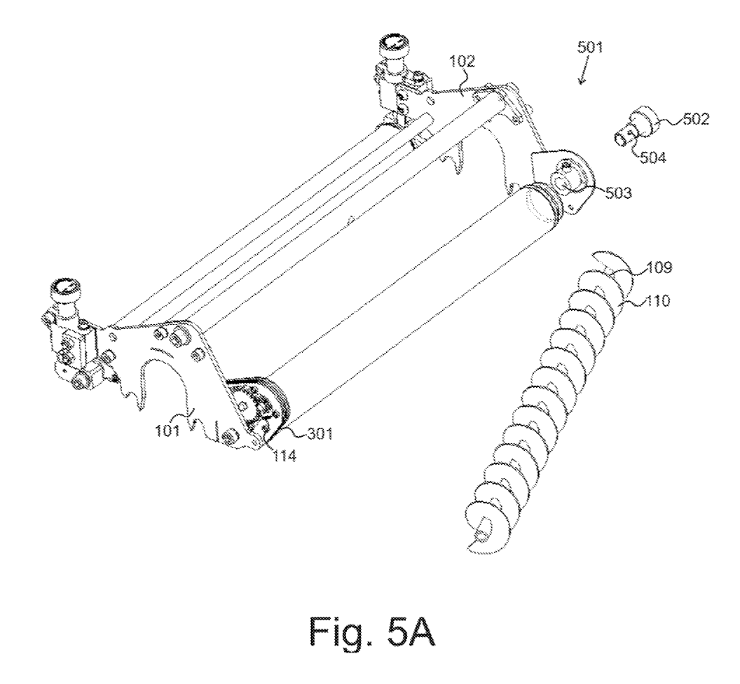

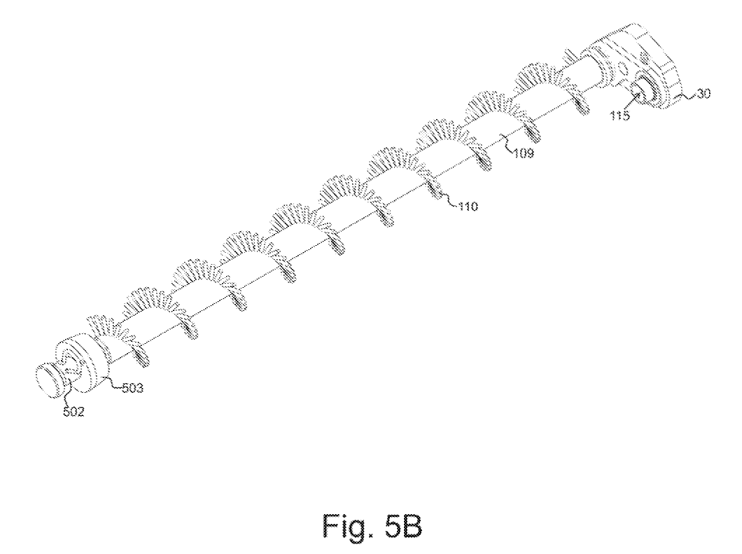

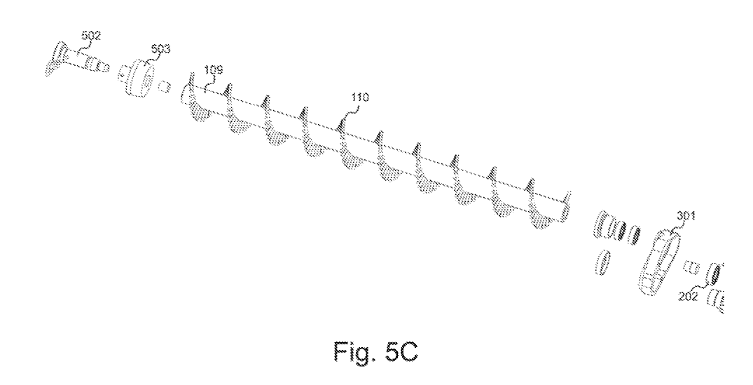

FIGS. 5A to 5C are schematic representations of an embodiment of a quick-release coupling means between the rotating assembly 108 and the end panel 102 of the grass treatment device 100, opposite the end panel 101 to which the driving means 114 are mounted.

The grass treatment device includes a quick-release mechanism 501 at the end of shaft 109 opposite the driving means 114, preferably doubling as the means for fastening shaft 109 to the end panel 102. The fastening means 501 comprises a releasable fastener member 502 for engaging the rotating assembly 108 across a through-bracket 503 in the end panel 102. The releasable fastener member 502 is adapted to co-axially engage the rotating assembly 108 and the through-bracket 503 is adapted to allow free rotation of the rotating assembly 108 and fastener member 502 secured to it, as driven by the driving means 114.

An outer surface of the fastener member 502 includes at least one projection 504 for engaging at least one complementary depression on the inner surface (not shown) of the longitudinal axis 208 of the rotating assembly 108. Alternatively, the outer surface of the fastener member includes at least one depression for engaging at least one complementary projection on an inner surface of the cleaning mechanism axis.

The at least one projection 505 is for instance a biased ball and the at least one depression may be a complementary socket. Depending on the particular application and/or scale of the rotating assembly 108, it may be preferable to include several combinations of complementary depressions and projections. It may also be preferable to additionally include releasable locking means on the fastener member and/or the cleaning mechanism axis 503.

With reference to FIGS. 6A, 6B and 6C, reference has previously been made to a treatment tool which does not generate debris and cuttings, which are therefore unlikely to accrue on the roller surface, whereby interaction between the rotating assembly 108 and the roller 104 is not desired. An example of such a treatment tool is a groomer, the purpose of which is to straighten grass blades prior to their cutting. The rotating assembly 108 may therefore be configured with a different type and configuration of bristles members 610, particularly oblong blades, arranged in a helical and serrated manner.

Conventionally, a groomer precedes the treatment tool and is not powered, to avoid unnecessarily straining the grass blades. A suitably configured rotating assembly 108 as may therefore be mounted substantially adjacent the first roller 103 instead, wherein the first roller 103 is disposed towards the front end of the device 100 relative to the direction of travel of the grass treatment device 100 when in use.

The quick-release coupling means 401, 501 allows a user to quickly and effortlessly remove a rotating assembly 108 comprising cleaning brush portions 110 as shown in FIGS. 1 to 5C, and replace it with a rotating assembly 108 comprising grooming brush portions 610.

The adjustment means 202 then allows a user to quickly and effortlessly disengage the driven gear 116 operably connected to the rotating assembly 108 comprising grooming brush portions 610, from the driving gear 115 operably connected to the roller 103 within the driving means 114, shown as sealed within an optional housing 301 in the Figures. In use, the grooming rotating assembly 108 is brought into contact with the grass surface and performs its function of standing grass blades up prior to their cutting.

The inventors have however determined that the rotating assembly 108 configured with roller-cleaning bristles members 110 may advantageously be used as a groomer, rather than resorting to alternative bristle elements 610, because it has been found to be less aggressive on the grass blades. More advantageously still, the inventors have also determined that the rotating assembly 108 configured with roller-cleaning bristles members 110 may advantageously be used for the dual purpose of grooming the grass blades and cleaning the adjacent roller 103.

The inventors consider the use of multiple rotating assemblies 108 in a grass treatment device 100, and the use of single or multiple rotating assemblies 108 in respective grass treatment devices 100 mounted to a same vehicle, as within the scope of the present disclosure.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A grass treatment device comprising:
a frame;
at least one roller mounted to the frame and configured to contact a grass surface;
a grass treatment tool mounted to the frame substantially adjacent the roller and configured to treat the grass surface;
a rotating assembly mounted substantially adjacent the roller, having a plurality of bristle members; and
driving means operably connecting the rotating assembly to the roller, comprising a gear mechanism having a first driving gear attached to an axis of the roller and a first driven gear attached to an axis of the rotating assembly.

2. A grass treatment device according to claim 1, wherein the gear mechanism comprises an idler gear located between the driving gear and the driven gear.

3. A grass treatment device according to claim 1, wherein the gear mechanism comprises means to adjust a distance between the driving gear and the driven gear.

4. A grass treatment device according to claim 3, wherein the means to adjust a distance between the driving gear and the driven gear comprises an eccentric mount.

5. A grass treatment device according to claim 1, wherein the driving means is sealed in a housing.

6. A grass treatment device according to claim 5, wherein the housing is made of a durable material, selected from the group comprising steel alloys, elastomer compounds and polymer compounds.

7. A grass treatment device according to claim 5, wherein the housing comprises respective apertures for accommodating the respective axes of the roller and the rotating assembly, the apertures being sealable by a seal or gasket.

8. A grass treatment device according to claim 1, wherein the first driving gear and the first driven gear are selected from the group comprising toothed gears, smooth gears and worm gears.

9. A grass treatment device according to claim 8, wherein the first driving gear, the first driven gear and the idle gear are substantially circular.

10. A grass treatment device according to claim 8, wherein the first driving gear and the first driven gear are smooth gears made of a substantially resilient material.

11. A grass treatment device according to claim 10, wherein the substantially resilient material is neoprene.

12. A grass treatment device according to claim 1, wherein the rotating assembly comprises an elongate body apt to rotate about its longitudinal axis.

13. A grass treatment device according to claim 1, further comprising fastening means for releasably fastening the rotating assembly to the frame opposite the driving means.

14. A grass treatment device according to claim 1, wherein the bristle members constitute at least one brush portion disposed in a substantially helical arrangement.

15. A grass treatment device according to claim 1, wherein the bristle members constitute a plurality of discrete brush portions spaced from one another at intervals.

16. A grass treatment device according to claim 1, wherein a ratio of rotation between the roller and the rotating assembly is selected from the group comprising a non-integer ratio and a ratio greater than 1:1 and less than 1:6.

17. A grass treatment device according to claim 1, wherein the rotating assembly is configured to rotate between 750 to 2500 rpm during use.

18. A grass treatment device according to claim 1, wherein the grass treatment tool comprises a removable grass treatment cassette, selected from the group comprising a spiker, a scarifer, a rotary brush, a roller, a vibrating roller and a cutter.

19. A kit of parts for a grass treatment device comprising at least one roller configured to contact a grass surface and a grass treatment tool substantially adjacent the roller and configured to treat a grass surface, the kit of parts comprising:
a rotating assembly apt to be mounted substantially adjacent the roller, comprising a plurality of bristle members; and
driving means operably connecting the rotating assembly to the roller, wherein the driving means comprises a gear mechanism having a first driving gear attached to an axis of the roller and a first driven gear attached to an axis of the rotating assembly.

20. A kit of parts according to claim 19, further comprising an idler gear apt to be located between the driving gear and the driven gear.

21. A kit of parts according to claim 19, further comprising an eccentric mount operable to adjust a distance between the driving gear and the driven gear.

22. A method of cleaning a roller of a grass treatment device comprising the roller, a grass treatment tool configured to treat a grass surface, a rotating assembly mounted substantially adjacent the roller and having a plurality of bristle members, and driving means comprising a gear mechanism having a first driving gear and a first driven gear, the method comprising the steps of:
operably connecting the first driving gear to an axis of the roller;
operably connecting the first driven gear to an axis of the rotating assembly; and
bringing the plurality of bristle members into contact with the roller in use.

23. The method of claim 22, wherein the gear mechanism further comprises an eccentric mount operable to adjust a distance between the driving gear and the driven gear, comprising the further step of adjusting a distance between the driving gear and the driven gear.

24. A method of grooming a grass surface before treatment by a grass treatment device comprising a roller, a grass treatment tool configured to treat the grass surface, a rotating assembly mounted substantially adjacent the roller and having a plurality of bristle members, and driving means comprising a gear mechanism having a first driving gear and a first driven gear, the method comprising the steps of:
operably connecting the first driving gear to an axis of the roller; operably connecting the first driven gear to an axis of the rotating assembly; and
bringing the plurality of bristle members into contact with the grass surface in use.

25. The method of claim 24, wherein the gear mechanism further comprises an eccentric mount operable to adjust a distance between the driving gear and the driven gear, comprising the further step of adjusting a distance between the driving gear and the driven gear.
